(19) United States
(12) Patent Application Publication
(10) Pub. No.: US 2022/0039414 A1
(43) Pub. Date: Feb. 10, 2022

(54) Method for Preparing Dehydrated Avocados by Microwave Drying

(71) Applicant: Laboratoires Expanscience, Paris La Défense Cedex (FR)

(72) Inventors: Gaelle Le Crouerour, Leves (FR); Delphine Taupin, Croth (FR); Iann Rance, Prunay en Yvelines (FR)

(73) Assignee: Laboratoires Expanscience, Paris La Défense Cedex (FR)

(21) Appl. No.: 17/280,511

(22) PCT Filed: Sep. 27, 2019
(86) PCT No.: PCT/EP2019/076300

§ 371 Date: Mar. 26, 2021

(30) Foreign Application Priority Data
Sep. 27, 2018 (FR) 1858914

(51) Int. Cl. A23B 7/02; A23L 19/00; A23L 3/54; C11B 1/04; C11B 1/08; C11B 3/00; C11B 7/00; C11C 1/02

(52) U.S. Cl. CPC A23B 7/02; A23L 19/07; A23L 3/54; C11C 1/025; C11B 1/08; C11B 3/008; C11B 7/0075; C11B 1/04

(57) ABSTRACT

The present invention concerns a method for preparing dehydrated avocados, a method for preparing an unsaponifiable-rich avocado oil, a method for preparing an avocado cake rich in sugars and proteins, and a method for preparing an unsaponifiable fraction; these methods all comprising a step of drying avocado slices by means of microwaves until dehydrated avocados are obtained having residual moisture less than or equal to 5%; during this step, the water evaporated under the action of the microwaves being eliminated by a warm air stream with a temperature less than or equal to 80° C. and/or by air extraction.

The present invention belongs to the field of preparing dehydrated avocados and avocado oil obtained from dehydrated avocados.

The present invention relates more specifically to a method for preparing dehydrated avocados and to a method for preparing an avocado oil rich in unsaponifiable matter, these two methods comprising a step of drying the avocado by microwaves.

Today, avocados have become a commonly consumed food. The avocado is rich in oil since lipids represent between 10 and 20% of the fresh fruit. The high fat content is one of the features of this fruit. The oil has been used for many years for its cosmetic and pharmaceutical applications. Moreover, due to its nutritional properties, it is very interesting as an edible oil or dietary supplement, and global production is continuously growing.

Crude or virgin avocado oils are generally extracted by a cold-press process, which consists of mixing fresh fruit, followed by a separation step of the three phases, solid, oily and aqueous, in a decanter centrifuge. A final clarifying phase by centrifugal clarification leads to a perfectly clear oil. Other methods, such as cold pressing with the addition of solid adjuvants or supercritical extraction also produce virgin oils.

Avocado oils can also be obtained from dried avocados. Heat-treating avocados reduces the residual humidity in the fruits to a content below 10%, making it possible to extract the oil by an organic solvent or by mechanical pressure.

However, such extraction methods including heating the avocado, generally in an oven or by hot air, can lead to degradation side reactions well known to the skilled person, such as Maillard reactions, or major chemical changes, especially in the presence of heat sensitive substrates such as lipids (e.g., unsaturated fatty acids) and the unsaponifiable fraction (e.g., vitamin E). Thus, heat processes will promote heat oxidation of substrates, free-radical producing reactions responsible for the appearance of peroxides, as well as intra or intermolecular condensation reactions that lead to the formation of heavy products of the Maillard reaction type.

Thus, the poor stability of some avocado constituents and the risks related to their potential toxicity make it necessary to control the fate of these constituents during the various steps of the method to produce a cosmetic, pharmaceutical or food grade oil. Consequently, there is a need to develop methods to obtain crude or refined avocado oils that do not have the disadvantages of the prior art and make it possible to market avocado oils safely.

Patent application EP 1,966,358 discloses a method for obtaining a refined avocado oil that makes it possible to substantially remove impurities specific to the avocado, such as acetogenins, also called “persin”, and degradation products responsible for bitterness. The method disclosed in EP 1,966,358 comprises a molecular distillation step judicially inserted between drying the fruits and refining the oil that makes it possible to eliminate undesired and unstable compounds.

The first step of the method disclosed in EP 1,966,358 is a step of controlled dehydration of the avocados at a temperature comprised between 70 and 90° C. This step is also generally done by oven drying or hot air drying and can last 8 to 36 hours until a residual humidity level of less than or equal to 5% is obtained in the fruit.

International applications WO 2013/098293, WO 2013/104795 and WO 2013104793 also disclose a method for obtaining a crude avocado oil by extraction by mechanical pressure. The methods described in all three of these international applications comprise a drying step at a high temperature comprised between 60° C. and 150° C., until a residual humidity less than or equal to 5% is obtained. In the examples of these international applications, the drying step is performed in an oven for 24 h, and up to 72 h.

In the above-mentioned applications, it is crucial to properly control this drying step in order to ensure that the dehydrated avocado has not been physically and chemically denatured, especially so that it still contains the compounds of interest for its nutraceutical, cosmetic or pharmaceutical uses, especially unsaponifiables. However, the drying methods until now, especially oven or hot air drying, are time and energy consuming and do not allow adjusting dryer capacity to variable quantities of avocados (the method is only appropriate/profitable from a minimum of tens of tons of avocados).

There is therefore a need for improving the avocado dehydration step for purposes of obtaining a dehydrated avocado and/or avocado oil from dehydrated avocados, similar to those obtained with a dehydration step by oven or hot air drying, but consuming less energy, saving time and giving access to greater flexibility with regard to the quantity of avocados to be dried (from a few tens of kg to a few tens of tons).

### SUMMARY OF THE INVENTION

The present invention meets the above-mentioned needs.

In the context of the present invention, the inventors have discovered that it was possible to obtain dehydrated avocados, notably having a residual humidity less than or equal to 5%, by a method comprising a microwave drying step.

The inventors notably discovered specific microwave drying conditions that made it possible to obtain whole dehydrated avocados having a residual humidity less than or equal to 5%, despite the fact that different parts of the avocado (skin, pit and pulp), taken individually, react differently to microwave drying.

The inventors notably discovered that in order to obtain dehydrated avocados having a residual humidity less than or equal to 5% by means of a microwave drying step, it is especially necessary to eliminate the water evaporated by the microwaves by means of a hot air stream of a temperature less than or equal to 80° C. and/or by air extraction. Likewise, it is also suitable to select fresh, whole avocados of medium or high hardness and slice them into strips.

The inventors more particularly discovered that the implementation of a microwave drying step under specific conditions did not deteriorate the characteristics of the dehydrated avocado thus obtained, nor of the oil obtained from said dehydrated avocados.

Thus, it was discovered that a microwave drying step made it possible to obtain a dehydrated avocado and/or avocado oil from dehydrated avocados, similar to those obtained with a dehydration step by oven or hot air drying, but consuming less energy, saving a substantial amount of time and giving access to greater flexibility with regard to the quantity of avocados to be dried.

The invention notably makes it possible to obtain an oil having a similar or even better content and quality of unsaponifiable matter than that obtained in the prior art by means of the drying step in an oven or hot air, for example.

Likewise, the present invention makes it possible to obtain cakes with a sugar content and, in particular, in specific C7 avocado sugars, similar or even better than that obtained in the prior art by means of the drying step in an oven or hot air, for example.

The present invention has for a first subject, a method for preparing dehydrated avocados comprising the following steps:
a) selecting fresh avocados having resistance strength to penetration into the flesh greater than 1 kg/m², said strength being measured using a penetrometer;
b) slicing the avocados selected into strips; and
c) drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;

The present invention has for a second subject, a method for preparing an avocado oil rich in unsaponifiable matter comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%; during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d), preferably by mechanical pressing; and
f) Recovery of the oil obtained, preferably by filtration.

The present invention has for a third subject, a method for preparing an avocado cake rich in sugars comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d), preferably by mechanical pressing; and
f) f) Recovering the cake obtained.

The present invention also concerns a dehydrated avocado that can be obtained by the method according to the first subject of the invention.

The present invention also concerns an avocado oil rich in unsaponifiable matter that can be obtained by the method according to the second subject of the invention.

The present invention also concerns an avocado cake rich in sugars that can be obtained by the method according to the third subject of the invention.

### DETAILED DESCRIPTION OF THE INVENTION

### Definition

Within the meaning of the invention, “soft avocado” or “avocado of low hardness” means an avocado with a penetration resistance of the flesh less than or equal to 1 kg/m². Within the meaning of the invention, “avocado of medium hardness” means an avocado with a penetration resistance of the flesh greater than 1 and less than or equal to 3 kg/m². Within the meaning of the invention, “hard avocado” or “avocado of high hardness” means an avocado with a penetration resistance of the flesh greater than 3 kg/m². Typically according to the present invention, the penetration strength is measured using a PCE-PTR 200 or FT 327 penetrometer, which measures the force in kilograms necessary to make a calibrated tip penetrate into the fruit. Advantageously, the fruit is peeled before doing the measurement in order to overcome the resistance of the skin (integument) and the variability relating to the different varieties of avocado tested. The rod, called a stylus or tip, used for this measurement has a nominal diameter of around 6 to 11.3 mm.

Within the meaning of the invention, “whole avocado” means avocados containing the skin, pulp and pit in their entirety.

Within the meaning of the present invention “pitted” avocados are whole avocados in which the pit has been removed, and which therefore only contain the skin and pulp.

Within the meaning of the present invention “skinless” avocados are whole avocados in which the skin has been removed, and therefore only contain the pulp and the pit.

Within the meaning of the present invention, “unsaponifiable” means all the constituents of a fatty substance which, after saponification in a strongly alkaline medium, are very slightly soluble or insoluble in water, and soluble in organic solvents, such as ethyl ether, aromatic hydrocarbons, chlorinated solvents, MeTHF, etc. The unsaponifiable matter is therefore composed of all the non-hydrolyzable constituents of the fat, as well as those resulting mainly from the saponification of non-glyceride esters of fatty acids (sterol and wax esters, tocopherol esters, etc.). Four large groups or families of substances are generally present in the majority of vegetable oil unsaponifiables. The largest group by mass is represented by the one that contains sterols, including pentacyclic triterpene alcohols and 4-methylsterols. The second group is made up of tocopherols that can integrate tocotrienols. The two other groups are aliphatic alcohols and saturated and unsaturated aliphatic hydrocarbons. The unsaponifiable composition of the avocado is differentiated from the standard composition found in vegetable oils because it predominantly integrates constituents specific to the avocado. The predominant unsaponifiable fraction of the avocado is represented by the group of acetogenins, which are precursor compounds of aliphatic furans. The second family of molecules includes polyhydroxylated fatty alcohols. The third group is made up of sterols including pentacyclic triterpenic alcohols and 4-methylsterols. The other groups are in the minority.

Within the meaning of the invention, “unsaponifiable-rich” means an oil that typically comprises at least 3% by mass of unsaponifiable matter, advantageously at least 5% by mass of unsaponifiable matter, relative to the total mass of the oil. For example, the oil comprises between 3 and 15% by mass of unsaponifiable matter, advantageously between 5 and 15%, in particular 8 to 12% by mass of unsaponifiable matter, relative to the total mass of the oil.

Within the meaning of the invention, “sugar” means all the carbohydrates present in the avocado and especially the water-soluble sugars of the avocado. The carbohydrates present in the avocado can be oses (such as C7 sugars), oligosaccharides, polysaccharides and/or sugar alcohols (such as perseitol). Avocado is particularly rich in sugars comprising 7 carbon atoms, commonly called “C7 sugars”, especially D-mannoheptulose and/or perseitol.

Within the meaning of the present invention, “avocado cake” means the solid residue obtained after extracting the avocado oil. The cake is typically obtained after filtration and separation of the avocado oil extracted from dehydrated avocados.

Within the meaning of the present invention, the term “sugar-rich avocado cake” means an avocado cake typically comprising at least 5% by mass of sugars, advantageously at least 10% by mass of sugars, more advantageously from 5 to 15% by mass of sugars, especially 10 to 15% by mass of sugars, relative to the total mass of the cake. The sugars present in the avocado cake advantageously comprise at least 80% of C7 sugars, including mannoheptulose and perseitol, and nonspecific avocado sugars such as fructose, sucrose, and glucose. For example, mannoheptulose will represent at least 35% of the sugars and perseitol will represent at least 35% of the sugars, relative to the total sugar mass contained in the cake.

Within the meaning of the present invention, the term “protein” means all the avocado proteins. A protein is a macromolecule made up of one or more chains of at least fifty amino acids called polypeptides, to which are often added various groups, and that have a three dimensional structure. Proteins typically have a molecular weight greater than 10000 Da.

Within the meaning of the present invention, the term “residual humidity” means the quantity of liquid contained in the sample after it has been subjected to a method to dry it. It is assessed relative to a weight or volume ratio. Residual humidity can be determined by methods well known to the skilled person, especially using a thermogravimetric method by IR drying. Other method can also be implemented, such as the oven-drying loss method or the Karl Fischer titration method.

Subject 1—Method for Preparing Dehydrated Avocados

The present invention has for a first subject, a method for preparing dehydrated avocados comprising the following steps:
a) selecting fresh avocados having resistance strength to penetration into the flesh greater than 1 kg/m², said strength being measured using a penetrometer;
b) slicing the avocados selected into strips; and
c) drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;

The present invention therefore has for a first subject a method such as described above for the preparation of dehydrated avocados having a residual humidity less than or equal to 5%.

The majority of avocado varieties can be used in the context of the present invention to produce dehydrated avocados. For example, the method according to the invention can be applied to the following non-exhaustive list of avocado varieties: Bacon, Collin, Duke, Edranol, Ettinger, Fuerte, Hass, Lula, Maluma, Mexicana, Nabal, Nava, Pinkerton, Queen, Ryan, Sultan, and Superfuerte.

Advantageously, the avocadoes used as the initial product can be whole avocadoes, pitted avocadoes, skinless avocadoes or mixtures thereof. More advantageously, the avocadoes used as initial product are whole avocadoes.

In the context of the present invention, fresh avocadoes must be selected according to their maturity. In fact, due to the constitution of the fruit in three distinct parts, the skin, the pulp and the pit, the behavior of the avocado during slicing will be very variable depending on its degree of maturity and firmness of the pulp and skin. In the first phase following harvest, the fruit has a structural and hardness homogeneity among the three parts favorable to its slicing; this is called hard avocado. As soon as the pulp starts to soften, the compartmental hardness of the fruit (pulp, skin, pit) becomes very heterogeneous and limits any industrial slicing because of the presence of the pit that remains very hard and the loss of consistency of the skin and the pulp. Moreover, drying whole soft fruit without preparation does not give satisfactory results because it leads to heterogeneous drying in residual free water favorable to the appearance of parasitic and heterogeneous reactions, degradation factors for the oil and its unsaponifiable matter.

Thus, in the context of the present invention, the fresh avocados selected in step a) are not soft avocados. Typically, soft avocados have a degree of softening equivalent to that for immediate consumption of the avocado and rule out slicing into strips. The avocados selected during step a) therefore have a resistance strength for penetration into the flesh greater than 1 kg/m², preferably greater than or equal to 2 kg/m², said strength being measured using a penetrometer.

Advantageously, the avocadoes selected during step a) are hard avocados, i.e., avocados having resistance strength to penetration into the flesh greater than 3 kg/m², said force being measured using a penetrometer;

During step b) of the method according to the invention, the avocados are advantageously sliced into strips using a disc slicer.

Advantageously, during step b), whole avocadoes are sliced into strips 1 to 5 mm thick, more advantageously from 1 to 3 mm thick, in particular 2 mm thick.

It was discovered that slicing avocados into strips has an influence on the homogeneity and final quality of the dehydrated avocados obtained. For example, cutting avocados into cubes does not allow drying the fruits to the center, which results in dehydrated avocados having more than 5% residual humidity, and an alteration in the unsaponifiable content of the oil obtained.

In the context of the present invention, the fresh avocado strips are dried by microwaving combined with a hot air injection and/or an air extraction.

A particular feature of microwave heating is that heating occurs from the inside to the outside. A few water molecules start to evaporate and induce partial pressures inside cells which cause water molecules that have not yet evaporated to be ejected. This creates a drying effect that makes it possible to extract a maximum amount of water with a minimum amount of energy. However, for maximum efficacy and especially to reach a residual humidity less than or equal to 5%, it was discovered that the water thus extracted must be eliminated from the microwave chamber, preferably continuously.

Thus, during step c) of the method according to the invention, the water evaporated by the action of the microwaves is eliminated by means of a hot air stream at a temperature less than or equal to 80° C. and/or by air extraction, advantageously by a hot air stream at a temperature less than or equal to 80° C., more advantageously at a temperature less than 80° C., in particular a temperature comprised between 40° C. and 60° C.

Advantageously, when the water evaporated under the action of the microwaves is eliminated by a hot air stream, the flow rate of this hot air stream is comprised between 2.5 and 500 m³/h, advantageously between 200 and 500 m³/h.

In the context of the present invention, it is suitable to adjust the microwave power in order to permit rapid drying of the avocados while preserving the compounds of interest such as sugars and unsaponifiables and while preventing the avocados from catching fire. Advantageously, in step c), the microwave power is comprised between 1000 and 5000 W, preferably between 2000 and 5000 W, in particular between 2500 and 5000 W, in particular for equipment operating at a microwave frequency of 2450 Mhz.

Depending on the microwave power selected as well as on the quantity of avocados to be dried, the duration of the drying step, i.e. step c, should be adjusted. The stronger the power, the shorter the duration. Likewise, the greater the quantity of avocados to be dried, the longer the duration. Thus the drying duration should be adjusted according to the drying yield obtained at a given microwave power.

Advantageously, for a microwave power comprised between 1000 and 5000 W, the drying duration is determined by considering that the drying yield is between 10 g and 2000 g, advantageously between 350 g and 2000 g, more advantageously between 700 g and 2000 g, in particular between 1250 g and 2000 g, of avocado strips obtained in step b) dried in 1 minute. In particular, for a microwave power comprised between 1000 and 3000 W, the drying duration is determined by considering that the drying yield is between 10 g and 700 g, advantageously between 350 g and 700 g, more advantageously between 500 g and 700 g, in particular between 600 g and 700 g, of avocado strips obtained in step b) dried in 1 minute, and for a microwave power comprised between more than 3000 and 5000 W, the drying duration is determined by considering that the drying yield is between 15 g and 2000 g, advantageously between 700 g and 2000 g, more advantageously between 1000 g and 2000 g, in particular between 1500 g and 2000 g, of avocado strips obtained in step b) dried in 1 minute.

The conditions selected for performing drying step c) are established for purposes of obtaining dehydrated avocados having a residual humidity less than or equal to 5%, preferably less than 5%, more advantageously less than 4%, while preserving the quality of dehydrated avocados and notably by preserving the compounds of interest such as sugars and unsaponifiables. Step c) of the method according to the invention is thus performed under conditions that make it possible to optimize energy needs and limit undesirable reactions

The present invention also concerns a dehydrated avocado that can be obtained by the method according to the first subject of the invention. Said dehydrated avocado has a residual humidity less than or equal to 5%, advantageously less than 5%, more advantageously less than 4%, and advantageously has a green to light brown color. Moreover, said dehydrated avocado advantageously has a “crackled” appearance, unlike fruits dried by freeze drying, which generally have a “smooth” appearance.

A residual humidity less than or equal to 5% plays an important role in the consistency of the dried avocados, conferring to them a brittle solid texture favorable for resisting the physical stresses developed during mechanical pressing. Beyond 5% humidity, the dried avocado has a soft consistency that leads to the formation of a puree during pressing, without sufficient consistency to be pressed effectively.

In one advantageous embodiment, the present invention has for a subject a method for preparing dehydrated avocados having a residual humidity less than or equal to 5% comprising the following steps:
a) selecting fresh avocados having resistance strength to penetration into the flesh greater than 1 kg/m², said strength being measured using a penetrometer;
b) slicing the whole avocados selected into strips, advantageously into strips 1 to 5 mm thick, more advantageously from 1 to 3 mm thick, in particular 2 mm thick; and
c) drying the avocado strips obtained in step b) by microwaves until dehydrated avocados are obtained with a residual humidity less than or equal to 5%, during this step, the water evaporated by the microwaves is eliminated by means of a hot air stream of a temperature between 40° C. and 80° C., with an air flow rate greater than 50 m³/h, advantageously greater than or equal to 150 m³/h, more advantageously between 180 and 500 m³/h,
   moreover, in step c), the microwave power is comprised between 1000 and 5000 W, preferably between 2000 and 5000 W, in particular between 2500 and 5000 W.

Subject 2—Method for preparing an avocado oil rich in unsaponifiables

The present invention has for a second subject, a method for preparing an avocado oil rich in unsaponifiable matter comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%; during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d), preferably by mechanical pressing; and
f) Recovery of the oil obtained, preferably by filtration.

In the context of this second subject of the invention, steps a) to c) are identical to the ones mentioned in the context of the method for preparing dried avocados (first subject). Thus, the part concerning subject 1 of the invention is repeated in full here.

Optional step d) of crushing the dehydrated avocados obtained in step c) can be carried out in order to facilitate the routing and preservation of dehydrated avocados to the pressing system. This step can be performed by methods known to the skilled person such as the use of a crusher (jaw, impact, cone), grinder (hammer, blade, cylinder), chopper, or mill.

Oil extraction step e) is implemented by mechanical pressing of the dried material, after implementation of drying step c) or crushing step d).

Advantageously, extraction step e) is performed at a temperature comprised between 80 and 100° C. This temperature is obtained and kept constant by all the available means such as preheating the press body, preheating the dried avocados then adding water to feed the press, heating the press body, etc.

In particular, maintaining the working temperature at a value greater than 80° C., more particularly at 100° C., guarantees a good extraction rate of the oil and notably improves the extraction yield of unsaponifiable constituents, especially acetogenins, aliphatic alcohols, sterols and/or saturated aliphatic hydrocarbons.

Extraction step e) according to the invention is generally completed by filtration that eliminates solid particles and guarantees that the oil produced will be clear.

The method according to the present invention makes it possible to produce a quality avocado oil with a particular composition, especially having a low acid index and a high potential of unsaponifiable matter and a particular composition of this unsaponifiable matter.

The present invention also concerns an avocado oil rich in unsaponifiable matter that can be obtained by the method according to the second subject of the invention.

The avocado oil according to the invention is an unsaponifiable-rich oil. Advantageously, according to the present invention, the oil contains at least 3%, more advantageously at least 5% by mass of unsaponifiable matter, relative to the total mass of the oil.

Advantageously, the unsaponifiable matter of the oil contains the following molecular families: saturated and unsaturated hydrocarbons, terpenic and aliphatic alcohols, sterols, tocopherols, carotenoids and xanthophylls.

In a particularly advantageous manner, the unsaponifiable matter of the oil according to the invention comprises 0 to 5% by mass of saturated aliphatic hydrocarbons. In particular, said saturated aliphatic hydrocarbons are typically linear, nonbranched hydrocarbons with an uneven number of carbons. Advantageously, the saturated aliphatic hydrocarbons are C₂₇, C₂₉ or C₃₁ alkanes.

In a particularly advantageous manner, the oil contains at least 0.5% by mass of sterols, advantageously at least 0.8% by mass of sterols, relative to the total mass of the oil. In particular, said sterols are advantageously chosen in the group made up of β-sitosterol, campesterol, stigmasterol, Δ5-avenasterol, Δ7-stignnasterol, citrostadienol, and mixtures thereof.

Advantageously, the unsaponifiable matter contained in the oil according to the invention also contains aliphatic acetogenins and/or derivatives thereof.

In the context of the invention, the aliphatic acetogenins and derivatives thereof are notably polyhydroxylated fatty alcohols and acetylated derivatives thereof, and/or 1,2-dihydroxy-4-oxo-aliphatic alcohols and acetylated “persin” derivatives thereof, and/or aliphatic furans, and mixtures thereof.

The polyhydroxylated fatty alcohols are also called Fraction I. They are especially 1,2,4-trihydroxy triols with long acetylenic and olefinic chains. The acetylated derivatives of polyhydric fatty alcohols are typically in position 1, 2 or 4.

The 1,2-dihydroxy-4-oxo-aliphatic alcohols are also called persins, and are precursors of Fraction H, i.e. aliphatic furans. They are notably 1-2-dihydroxy-4-oxo diol ketones with long acetylenic and olefinic chains. The acetylated derivatives of these compounds are typically in position 1.

Persins are typically found in idioblasts, oleaginous cells in the case of avocados.

For example, persins with the following molecular structure can be named:

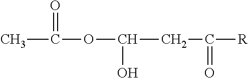

Aliphatic furans are also called furan lipids, or more commonly avocadofurans or Fraction H. They are, in particular, persin derivatives comprising a furan group, which result in particular from the chemical transformation by dehydration and intramolecular cyclization of the persins extracted from the avocado. 2-alkyl furans can be names as an example.

Advantageously, the unsaponifiable matter of the oil according to the present invention is rich in aliphatic acetogenins and/or derivatives thereof. In a particularly advantageous manner, the oil typically contains at least 2% by mass of aliphatic acetogenins and/or derivatives thereof, typically at least 3% by mass of aliphatic acetogenins and/or derivatives thereof, relative to the total mass of the oil. For example, the oil contains between 2 and 10%, in particular between 3 and 10%, more particularly between 5 and 8% by mass of aliphatic acetogenins and/or derivatives thereof, relative to the total mass of the oil.

The present invention also concerns a method for preparing an avocado unsaponifiable comprising steps a) to f) mentioned above as well as the following steps:
g) alternatively:
   i. Heat treatment of the oil extracted at a temperature advantageously comprised between 80 and 150° C., then concentration of the oil in its unsaponifiable fraction, or
   ii. Concentration of the oil in its unsaponifiable fraction, then heat treatment at a temperature advantageously comprised between 80 and 150° C.,
h) followed by a step of saponification and extraction of the unsaponifiable matter,
i) and optionally at least one purification and/or fractionation.

The step of concentrating the oil in its unsaponifiable fraction to prepare a concentrate, implemented in step g)i. or g)ii., is advantageously conducted by cold crystallization or molecular distillation. Advantageously, the unsaponifiable concentrate of avocado oil is prepared by molecular distillation, typically at a temperature between 180° C. and 260° C., while maintaining a pressure comprised between 10⁻² et 10⁻³ mmHg.

This molecular distillation step of the avocado oil is preferably performed by using a device chosen from centrifugal type molecular stills and wiped film type devices.

The heat treatment step of the oil or concentrate, implemented in step g)i. or (g)ii., is generally performed at a temperature between 80° C. and 150° C., for example between 80° C. and 130° C.

The method for preparing the avocado unsaponifiable matter also comprises a step h) of saponification and extraction of the unsaponifiable matter, for example using a solvent.

In particular, step h) of saponification and extraction of the unsaponifiable matter can be implemented in the presence of potash or sodium hydroxide in an alcoholic, preferably ethanolic, medium followed by one or more extraction(s). Extraction by an appropriate organic solvent (liquid-liquid extraction) in view of separating the fatty acid soaps and unsaponifiable compounds, is particularly suitable. The appropriate organic solvent can be chosen, for example, from the group of alkanes, halogenated alkanes, aromatic and halogenated aromatic solvents, ethers, ketones, esters, solvents comprising at least one silicon atom or any other suitable solvent immiscible with the hydroalcoholic solution.

Following extraction of the unsaponifiable matter, additional steps i) of purification or fractionation can be conducted.

The present invention also concerns an avocado unsaponifiable enriched in furan lipids, that can be obtained by the method according to the invention.

Advantageously according to the present invention, the unsaponifiable matter contains at least 45%, more advantageously 45% to 78% by mass of furan lipids, relative to the total mass of unsaponifiable matter.

Advantageously, the unsaponifiable matter also contains at least 3%, more advantageously 3 to 8% by mass of sterols, relative to the total mass of unsaponifiable matter.

Advantageously, the unsaponifiable matter contains at least 0.5%, more advantageously from 0.5 to 5% by mass of squalene relative to the total mass of unsaponifiable matter.

Advantageously, the unsaponifiable matter contains 0 to 5% by mass of saturated aliphatic hydrocarbons, relative to the total mass of unsaponifiable matter.

Subject 3—Method for preparing a cake rich in sugars and proteins

The present invention has for a third subject, a method for preparing an avocado cake rich in sugars comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d), preferably by mechanical pressing; and
f) Recovering the cake obtained, preferably after filtration of the oil obtained in step e).

In the context of this third subject of the invention, steps a) to c) are identical to the ones mentioned in the context of the method for preparing dehydrated avocados (first subject). Thus, the part concerning subject 1 of the invention is repeated in full here.

Likewise, steps d) and e) are identical to those mentioned in the context of the preparation of an avocado oil rich in unsaponifiable matter (second subject of the invention). Thus, the parts concerning steps d) and e) mentioned in subject 2 of the invention are repeated in full here.

Finally, step f) is advantageously conducted in a manner similar to step f) mentioned in the context of the preparation of an avocado oil rich in unsaponifiable matter (second subject of the invention) with the exception of the fact that the cake and not the oil is then recovered.

The present invention also concerns an avocado cake rich in sugars that can be obtained by the method according to the third subject of the invention.

Advantageously, the cake according to the invention comprises at least 5% of sugars, in particular from 5% to 15% of sugars, more particularly from 10 to 15%, expressed by weight relative to the total weight of the cake.

In the context of the present invention, the sugars are advantageously chosen from among C7 sugars such as mannoheptulose and perseitol, and nonspecific avocado sugars such as fructose, sucrose and glucose.

Advantageously, the cake according to the invention comprises at least 5% of proteins, preferably from 5% to 10%, more particularly from 6% to 10%, expressed by weight relative to the total weight of the cake.

In the context of the present invention, the proteins are advantageously chosen from among storage and structural proteins found specifically in whole avocado fruit.

The following examples are intended to illustrate the present invention.

### EXAMPLES

### Examples: Analysis of the Influence of the Operating Conditions on Microwave Drying According to the Invention

Equipment
Krups electric slicer
Retsh GM200 mill
KOMET Press
Thermoscientific centrifuge
Biichner filter
Allcat FT 327 penetrometer
Memmert oven
Closed microwave oven with turntable
Extractor 200 closed microwave oven
Continuous microwave oven with belt
Continuous microwave oven with worm

### Experimental Procedure

a) Protocol for Oven Drying Fresh Avocado (Control):

Fresh and hard avocados are thinly sliced into 1 to 2 mm strips then spread over 2 oven trays so as to obtain a layer of 2 cm maximum thickness (800 g of avocados per tray). They are immediately oven dried at T=80±5° C., until fruits dry on the outside and in the center are obtained, green to light brown in color.

The residual humidity is tested by the infrared technique (performed on the finely milled product).

Since the objective is to obtain a residual humidity less than or equal to 5%, drying is stopped as soon as the residual humidity meets this objective. The fruits must remain green to light brown in color.

b) Protocol for Drying Fresh Avocados by Microwaves at the Pilot Scale:

Fresh avocados are sliced in to 1 to 2 mm strips using an electric slicer and then immediately dried in a closed microwave oven with a turnable provided with a microwave generator.

As part of the process of optimizing operating conditions, the various tests performed made it possible to test the impact of the following parameters:
Microwave power;
Air stream temperature;
Drying duration;
Flow rate of the blown air;
Maturity of the avocados;
Format of the avocado pieces; and
Temperature of the avocados coming from drying.

c) Protocol for Extracting the Oil:

The dried avocados are crushed then pressed in a screw press. The crude oil is centrifuged, filtered and subjected to analysis.

d) Protocol for Analyzing the Oil:

The oil is analyzed by gas phase chromatography in order to determine the content of unsaponifiable matter. The analysis is carried out according to the following principle: saponification of a test sample containing cholestanol and squalane as internal standards, extraction of the unsaponifiable matter then determination of the sterol silyl ethers, of Fractions “H” and “IA” and squalene by gas chromatography on a capillary column.

e) Protocol for Extracting and Analyzing the Cake:

The total sugars are extracted with demineralized water. After stirring and centrifugation, the supernatant is sampled and analyzed by HPLC in order to determine the sugar profile of the total extract.

The protein content of the cake is determined by the Kjeldahl method.

### Example 1: Microwave Power

### a) Avocados

Fresh, hard avocados, from Peru, of the Hass variety were provided. The approximate size of the fruits is 200 g.

### b) Detailed Experimental Procedure

b1) Comparative: Oven Drying Fresh Avocado (Control)

The results of the control test are shown in Table 1:

TABLE 1
Results of the Control test of Example 1

| | | | % | |
|---|---|---|---|---|
| | Drying | Humidity | unsaponifiable | |
| Drying time | temperature | (% | matter | % sugars |
| (h, min, s') | (° C.) | relative) | (in the oil) | (in the cake) |
| 8 h | 80 | 2.5 | 13.0 | 10.8 |

b2) Invention: Drying Fresh Avocados by Microwave at the Laboratory Scale:

Fresh hard avocados are sliced into 1 to 2 mm strips and then immediately dried in a closed microwave oven with a turntable, provided with a microwave generator, the power of which is successively adjusted from 600 to 5000 W. The drying time has been adapted according to the power chosen in order to achieve a residual humidity less than or equal to 5% without damaging the fruits. The microwave frequency was set at 2450 Hz and the air stream temperature was set at 20° C. for the first 5 tests and 60° C. for the last two tests.

The various tests performed made it possible to test the impact of power:

Results (Table 2):

TABLE 2
Results of tests according to microwave power

| | Drying | | % unsaponifiable | |
|---|---|---|---|---|
| Power | duration; | Humidity | matter (in the | % sugars |
| (W) | (min) | (% relative) | oil) | (in the cake) |
| 600 | 33 | 16.7 | ND | ND |
| 1200 | 15 | 9.0 | ND | ND |
| 3200 | 8 | 9.4 | 10.7 | 9.5 |
| 4800 | 5 | 5.6 | 19.0 | 10.6 |
| 5000 | 5 | flames | ND | ND |
| 800 | 27.6 | 3.9 | 10.8 | 9.5 |
| 1000 | 21.6 | 3.5 | 11.3 | 10.4 |

### Conclusions

The drying performance is commensurate with the microwave power. This high power enables the avocados to be dried quickly and preserves the content of unsaponifiable matter of the avocados. However, a microwave power of 5000 W can cause the fruits to dry too fast so that they catch on fire. It is consequently necessary to adjust the exposure time.

These tests were performed in order to analyze the influence of microwave power on drying of the avocados. The first 5 tests are nevertheless not representative of the invention since the hot air generator ensuring the ventilation of the chamber is not used here.

### Example 2: Air Stream Temperature

### a) AVOCADOS

Fresh avocados, of medium hardness, from Chili, of the Hass variety were provided. The approximate size of the fruits is 200 g.

### b) Detailed Experimental Procedure

b1) Comparative: Oven Drying Fresh Avocado (Control)

The results of the Control test are shown in Table 3:

TABLE 3
Results of the Control test of Example 2

| | | | % | |
|---|---|---|---|---|
| | Drying | Humidity | unsaponifiable | |
| Drying time | temperature | (% | matter | % sugar |
| (h, min, s) | (° C.) | relative) | (in the oil) | (in the cake) |
| 8 h | 80 | 4.2 | 8.0 | 11.3 |

b2) Invention: Drying Fresh Avocados by Microwave at the Pilot Scale:

Approximately 550 g of fresh avocados of medium hardness (between 1 and 3 kg/m²) are sliced into 1 to 2 mm strips using an electric slicer then immediately dried by the Extractor 200 which has a 5 L bowl and a microwave generator set at 1000 W and a frequency of 2450 Hz. A hot air generator ventilates the chamber. The mean drying duration is approximately 22 minutes.

The various tests performed made it possible to test the impact of the blown air temperature:

Results (Table 4):

TABLE 4
Results of the tests according to air flow temperature

| | | % unsaponifiable | |
|---|---|---|---|
| | Humidity | matter | % sugars |
| Air flow T (° C.) | (% relative) | (in the oil) | (in the cake) |
| 40 | 11.0 | 10.6 | 10.2 |
| 60 | 4.7 | 10.7 | 13.2 |
| 80 | 2.9 | 9.1 | 6.9 |

### Conclusions

The presence of a hot air stream allows faster and better drying. From 60° C., a compliant humidity is quickly reached while preserving the unsaponifiables. Below 60° C., drying is possible but a longer exposure time to microwaves is necessary. A 80° C., a change in the total sugar content of the avocado cakes is observed (38.9% reduction of the sugars relative to the Control oil obtained with oven-dried avocados).

### Example 3: Drying Duration

### a) Avocados

Fresh avocados, of medium hardness, from Chili, of the Hass variety were provided. The approximate size of the fruits is 200 g.

### b) Detailed Experimental Procedure

b1) Comparative: Oven Drying Fresh Avocados (Control):

The results of the Control test are shown in Table 5:

TABLE 5
Results of the Control test of Example 3

| | | | % unsaponifiable |
|---|---|---|---|
| Drying time | Drying | Humidity | matter |
| (h min, s) | temperature (° C.) | (% relative) | (in the oil) |
| 8 h | 80 | 3.7 | 13.7 |

b2) Invention: Drying Fresh Avocados by Microwave in Continuous Mode:

Approximately 300 g of fresh avocados of medium hardness are sliced into 1 to 2 mm strips using an electric slicer then immediately dried in a continuous microwave oven with a belt and a microwave generator set at a power of 3000 W and a frequency of 2450 Hz. A hot air generator at 80° C. ventilates the chamber

The various tests performed made it possible to test the impact of drying duration.

Results (Table 6):

TABLE 6
Results of the tests according to drying time

| Drying time | Humidity | % unsaponifiable matter |
|---|---|---|
| (h, min, s) | (% relative) | (in the oil) |
| 11 min 30 s | 10.5 | 9.3 |
| 15 min | 3.8 | 8.1 |
| 18 min 40 s | 2.7 | 13.9 |

### Conclusions

The water content of the avocados decreases with time of exposure to microwaves.

The drying duration should make it possible to attain a residual humidity ≤5% conforming to our specifications so as to preserve the chemical integrity of the unsaponifiables. Thus, the drying yield could be defined as being the quantity of fresh avocados whose residual humidity was reduced to less than 5% in one minute.

### Example 4: Blown Air Flow Rate

### a) Avocados

Fresh avocados, of medium hardness, from Chili, of the Hass variety were provided. The approximate size of the fruits is 200 g.

### b) Detailed Experimental Procedure

b1) Comparative: Oven Drying Fresh Avocado (Control)

Results of the Control Test (Table 7):

TABLE 7
Results of the Control test of Example 4

| | | | % unsaponifiable |
|---|---|---|---|
| Drying time | Drying | Humidity | matter |
| (h, min, s) | temperature (° C.) | (% relative) | (in the oil) |
| 8 h | 80 | 3.7 | 13.7 |

b2) Invention: Drying Fresh Avocados by Microwave in Continuous Mode:

Approximately 300 g of fresh avocados of medium hardness are sliced into 1 to 2 mm strips using an electric slicer then immediately dried in a continuous microwave oven with a conveyor belt and a generator set at a power of 3000 W and a frequency of 2450 Hz. A hot air generator at 80° C. ventilates the chamber

The various tests performed made it possible to test the impact of the blown air flow rate:

Results (Table 8):

TABLE 8
Results of tests according to air flow rate

| Air stream flow rate | Humidity | % unsaponifiable matter |
|---|---|---|
| (m³/h) | (% relative) | (in the oil) |
| 120 | 10.5 | 9.3 |
| 180 | 3.8 | 8.1 |
| 210 | 2.7 | 13.9 |

### Conclusions

A flow rate that is too low does not allow effective drying of the avocado strips. The flow rate should therefore preferably be fairly powerful to make it possible to continuously eliminate the steam generated during drying of the fruit. The unsaponifiable content is thus preserved. The flow rate should preferably be at least 50 m³/h, in particular from 50 to 500 m³/h, more particularly from 180 to 500 m³/h.

### Example 5: Maturity of the Avocados

### a) AVOCADOS

Fresh avocados, from Chili, of the Hass variety were provided. The approximate size of the fruits is 200 g.

The firmness of the avocados is assessed with a penetrometer. It defines the force necessary (in kg/cm²) to make a needle of a calibrated size penetrate into the fruit. Before the measurement, the fruit is peeled to remove the resistance of the skin (integument). The rod, also called tip or nozzle, used for this measurement has a nominal diameter of around 8 mm. The hard avocados used had a resistance to penetration into the flesh greater than or equal to 3 kg/cm². The soft avocados used had a penetration resistance less than or equal to 1 kg/cm². So-called medium hardness avocados have an intermediate resistance to penetration, of 1 (not inclusive) to 3 kg/m².

### b) Detailed Experimental Procedure

b1) Comparative: Oven Drying Fresh Avocado (Control)

Results of the Control Test (Table 9):

TABLE 9
Results of the Control test of Example 5

| | | | % | |
|---|---|---|---|---|
| | Drying | Humidity | unsaponifiable | |
| Drying time | temperature | (% | matter | % sugar |
| (h, min, s) | (° C.) | relative) | (in the oil) | (in the cake) |
| 8 h | 80 | 4.2 | 8.0 | 11.3 |

b2) Invention: Drying Fresh Avocados by Microwave at the Pilot Scale:

Approximately 550 g of fresh avocados are sliced into 1 to 2 mm strips with an electric slicer and immediately dried in the Extractor 200 under an air stream at 60° C. The microwave power is set between 800 and 1150 W. The microwave frequency is set at 2450 Hz

In order to have tests on fruits of different maturities, the tests are performed twice, with a day in between, every other parameter being equivalent.

Results (Table 10):

TABLE 10
Results of the tests according to the
extent of ripening of the avocados

| | | | |
|---|---|---|---|
| | | % unsaponifiable | |
| Resistance of the | Humidity | matter | % sugars |
| fruit (kg/cm²) | (% relative) | (in the oil) | (in the cake) |

Conditions No. 1: 1000 W, 20 min of drying

| | | | |
|---|---|---|---|
| ≥3 | 4.7 | 10.7 | 13.2 |
| ≤1 | 3.8 | 9.3 | 9.7 |

Conditions No. 2: 800 W, 27 min of drying

| | | | |
|---|---|---|---|
| ≥3 | 4.7 | 11.5 | 11.1 |
| ≤1 | 3.9 | 10.8 | 9.5 |

### Conclusions

Regardless of the conditions for drying avocados by microwave, the unsaponifiable content of the oil is lesser when the avocados used are more mature. The sugar content of the cakes is also reduced.

### Example 6: Format of the Avocado Pieces

### a) AVOCADOS

Fresh, hard avocados, from Chili, of the Hass variety were provided. The approximate size of the fruits is 200 g.

### b) Detailed Experimental Procedure

b1) Comparative: Oven Drying Fresh Avocado (Control)

Results of the Control Test (Table 11):

TABLE 11
Results of the Control test of Example 6

| | | Humidity | |
|---|---|---|---|
| Drying time | Drying temperature | (% | % unsaponifiable matter |
| (h, min, s) | (° C.) | relative) | (in the oil) |
| 8 h | 80 | 3.7 | 13.7 |

b2) Invention: Drying Fresh Avocados by Microwave in Continuous Mode:

Between 300 and 600 g of fresh avocados are sliced in to 1 to 2 mm strips or cut into 1.5 cm cubes and then immediately dried in a closed microwave oven with a conveyor belt provided with a microwave generator. The power is set at 3000 W, the frequency at 2450 Hz, and the air stream at 3000 L/min and 85° C. The drying time is similar for both tests (18 min 40 s).

The different tests performed made it possible to test the impact of the shape of the avocado pieces during microwave drying:

Results (Table 12):

TABLE 12
Results of tests according to the cutting of the avocados

| | Humidity | % Unsaponifiable matter |
|---|---|---|
| Format of the avocados | (% relative) | (in the oil) |
| slices | 2.7 | 13.9 |
| cubes | 10.1 | 10.5 |

### Conclusions

Cutting avocados into cubes does not allow drying the fruits to the center which has a negative impact on the drying quality and changes the unsaponifiable content of the oil obtained.

### Example 7: Format and Parts of the Avocado Pieces

### a) Avocados

16 Hass avocados, hard and green, of the Hass variety and of Peruvian origin, stated to be from the same batch of fruits, were provided the morning of their use.

### b) Detailed Experimental Procedure

The avocados were dried by means of a GFMO 01 microwave oven

For each test performed, 250 g of fruits are distributed over the microwave oven plate. The tests are duplicated. Each operating condition therefore requires 500 g or around 2 avocados.

A microwave power of 600 W is applied for 22 min for each test. The microwave chamber is regularly ventilated in order to evacuate the steam, in order to reproduce the air stream present in the pilot tests.

The tests performed on the dry avocados to assess the drying performance are:
Fruit color: observing the fruit (appearance, color) makes it possible to assess the drying efficacy and the absence of degradation of the matter. The color should be green to light brown. A dark brown a to black color indicates carbonization of the fruit and therefore a change in the chemical integrity of the matter (and therefor a degradation of the desired active ingredients).
Residual humidity, measured by the infrared technique (performed on the finely milled product), makes it possible to ensure that the 5% max threshold is attained (Expanscience specification).

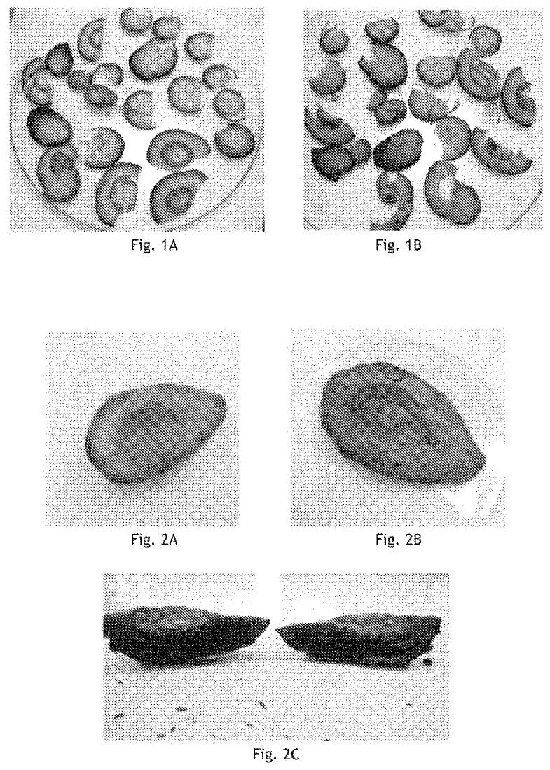

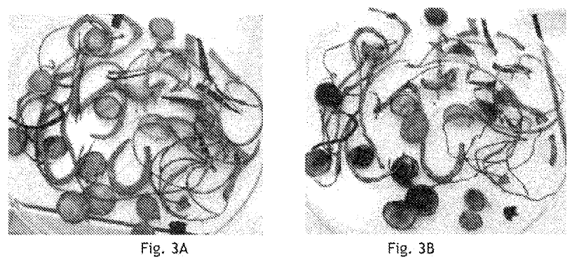

Three drying steps are thus performed:
1. 2×250 g of whole avocado, with the skin and pit, sliced into strips 3 mm thick. FIG. 1 shows the samples of test 1 before drying (FIG. 1A) and after drying (FIG. 1B).
2. 2×250 g of peeled and pitted avocado, cut in half. FIG. 2 shows the external appearance of the samples from Test 2 before drying (FIG. 2A) and after drying (FIG. 2B), and the center appearance of the samples from Test 2 after drying (FIG. 2C).
3. 250 g of skin and pit, sliced into strips 3 mm thick. FIG. 3 shows the samples of test 3 before drying (FIG. 3A) and after drying (FIG. 3B).

Results (Table 1213):

TABLE 13
Results of tests according to the cutting of the avocados

| | Test 1 | Test 2 | Test 3 |
|---|---|---|---|
| Power (W) | 600 | 600 | 600 |
| Time (per | 12 | 12 | 12 |
| avocado) (min) | | | |
| Appearance | Correct, ideal and | Burned at the | Partially burned, |
| | homogeneous | center, not | not homogeneous |
| | | homogenous | |
| Initial mass (g) | 100 | 100 | 100 |
| Mass after | 27.4 | 33.7 | 27.1 |
| drying (g) | | | |
| Humidity level | 2.27 | 4.9 | 0.86 |
| (%) | | | |

### Conclusions

In the context of drying a peeled and pitted avocado cut in half (test 2), it is not possible to reach the desired degree of drying without altering the composition. Carbonization of the avocado at the center but not at the surface is observed. Therefore, drying was heterogenous.
In the context of drying sliced skins and pits, it is not possible to attain the required degree of drying of the skin and pit of the avocado without altering the composition. A partial carbonization of the pits is observed. Drying was therefore heterogenous.

These tests show that the various parts of the avocado react differently to microwave drying under equivalent conditions. Contrary to tests using parts of avocado taken in isolation (flesh or skin/pit), the use of a whole sliced avocado leads to consistent, homogeneous drying without altering the material; despite the presence of the 3 different parts of the avocado.

1. Method for preparing dehydrated avocados comprising the following steps:
a) selecting fresh avocados having resistance strength to penetration into the flesh greater than 1 kg/m², said strength being measured using a penetrometer;
b) slicing the whole avocados selected into strips; and
c) drying the avocado strips obtained in step b) by microwaves until dehydrated avocados are obtained with a residual humidity less than or equal to 5%; during this step, the water evaporated by the microwaves is eliminated by means of a hot air stream of a temperature less than or equal to 80° C. and/or by air extraction.

2. Method according to claim 1, wherein during step b), whole avocados are sliced into strips 1 to 5 mm thick.

3. Method according to claim 1, wherein during step c), the water evaporated by the action of the microwaves is eliminated by a hot air stream at a temperature less than 80° C.

4. Method according to claim 1, wherein during step c), the hot air flow rate is greater than 50 m³/h.

5. Method according to claim 1, wherein during step c), the microwave power is comprised between 1000 and 5000 W.

6. Method for preparing an avocado oil rich in unsaponifiable matter comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d); and
f) Recovering the oil obtained, preferably after filtration of the oil obtained in step e).

7. Method for preparing an unsaponifiable fraction of avocado comprising the following steps:
steps a) to f) as defined in claim 6,
a step g), alternatively:
i. heat treatment of the oil extracted at a temperature advantageously comprised between 80 and 150° C., then concentration of the oil in its unsaponifiable fraction, or
ii. concentration of the oil in its unsaponifiable fraction, then heat treatment at a temperature advantageously comprised between 80 and 150° C.,
followed by a step h) of saponification and extraction of the unsaponifiable matter,
and optionally a step i) of at least one purification and/or fractionation.

8. Method for preparing an avocado cake rich in sugars comprising the following steps:
a) Selecting fresh avocados having resistance strength to penetration into the flesh greater than 1 kg/m², said strength being measured using a penetrometer;
b) Slicing the whole avocados selected into strips;
c) Drying the avocado strips obtained in step b) by microwaves until dehydrated avocados are obtained with a residual humidity less than or equal to 5%, during this step, the water evaporated by the microwaves is eliminated by means of a hot air stream of a temperature less than or equal to 80° C. and/or by air extraction;
d) Optionally, crushing the dehydrated avocados obtained in step c);
e) Extracting the oil from the dehydrated avocados obtained in step c) or d); and
f) Recovering the cake obtained, preferably after filtration of the oil obtained in step e).

9. Method according to claim 6, wherein step e) of extracting the oil is done by mechanical pressing at a temperature comprised between 80 and 100° C.

10. Method according to claim 6, wherein the avocado oil obtained comprises a content of unsaponifiable matter of at least 3%, relative to the total mass of the oil.

11. Method according to claim 8, wherein the avocado cake obtained comprises a sugar content of at least 5% by weight, relative to the total weight of the cake.

12. Method according to claim 8, wherein the avocado cake obtained comprises a protein content of at least 5% by weight, relative to the total weight of the cake.

13. Method according to claim 2, wherein during step b), whole avocados are sliced into strips 1 to 3 mm thick.

14. Method according to claim 2, wherein during step b), whole avocados are sliced into strips 2 mm thick.

15. Method according to claim 3, wherein during step c), the water evaporated by the action of the microwaves is eliminated by a hot air stream at a temperature comprised between 40° C. and 80° C.

16. Method according to claim 3, wherein during step c), the water evaporated by the action of the microwaves is eliminated by a hot air stream at a temperature comprised between 40° C. and 60° C.

17. Method according to claim 4, wherein during step c), the hot air flow rate is greater than or equal to 150 m³/h.

18. Method according to claim 5, wherein during step c), the microwave power is comprised between 2000 and 5000 W.

19. Method according to claim 10, wherein the avocado oil obtained comprises a content of unsaponifiable matter of at least 5% by mass, relative to the total mass of the oil.

20. Method according to claim 12, wherein the avocado cake obtained comprises a protein content of 5% to 10% by weight, relative to the total weight of the cake.
